(19) United States
(12) Patent Application Publication
(10) Pub. No.: US 2025/0252365 A1
(43) Pub. Date: Aug. 7, 2025

(54) Methods for Prescriptive Vegetation Management to Improve Energy Grid Reliability and Resilience

(71) Applicant: Quanta Technology, LLC, Raleigh, NC (US)

(72) Inventors: Shuaiang Rong, Chicago, IL (US); Andrija Sadikovic, San Ramon, CA (US)

(21) Appl. No.: 18/430,797

(22) Filed: Feb. 2, 2024

(51) Int. Cl. G06Q 10/0631

(52) U.S. Cl. CPC G06Q 10/06311

(57) ABSTRACT

Methods for planning vegetation trimming for maintenance of an electric power distribution system. An example method comprises correlating normalized difference vegetation index (NDVI) data extracted from satellite imagery with electrical system outage data mapped to power distribution system line segments, to generate vegetation proxy index data spatially associated with said power distribution line segments. The example method further comprises predicting vegetation related outage events and/or numbers of customers affected by device protective zone, based on the vegetation proxy index data, and identifying prioritized areas for vegetation management based on the predicted outage events and/or numbers of affected customers.

### TECHNICAL FIELD

The present application relates generally to electrical power distribution networks and relates more particularly to techniques for planning vegetation trimming for maintenance of an electric power distribution system.

### BACKGROUND

Existing methods for vegetation management around electric grid components identify vegetation risks based on satellite imagery. Existing analytics-based vegetation trimming methods use proximity of vegetation to electrical components as a deciding factor for vegetation management decision making. The proximity is estimated by personnel observation from the ground or estimated from imagery recorded by satellites or drones to improve electric grid reliability.

These approaches can yield effective trimming from proximity perspective, but are not always optimal from system reliability and resilience improvement perspective. Improvements are needed.

### SUMMARY

As briefly noted above, existing analytics-based methods are not always as effective as desired, with respect to system reliability and system resilience. This is at least partly because improved system reliability and resilience are regarded as simply the result of vegetation trimming decisions, rather than as inputs to a control function. Embodiments of the techniques and systems herein place vegetation trimming in a causal relationship with the system reliability and resilience, allowing system reliability and resilience performance to be directly controlled and optimized by the vegetation trimming decisions.

More particularly, embodiments herein include methods for planning vegetation trimming for maintenance of an electric power distribution system. An example method comprises correlating normalized difference vegetation index (NDVI) data extracted from satellite imagery with electrical system outage data mapped to power distribution system line segments, to generate vegetation proxy index data spatially associated with said power distribution line segments. The example method further comprises predicting vegetation related outage events and/or numbers of customers affected by device protective zone, based on the vegetation proxy index data, and identifying prioritized areas for vegetation management based on the predicted outage events and/or numbers of affected customers.

Other embodiments include computing devices configured for planning vegetation trimming for maintenance of an electric power distribution system. An example computing device comprises processing circuitry and memory operatively coupled to the processing circuitry and storing program instructions for execution by the processing circuitry, whereby the processing circuitry is configured to carry out operations corresponding to the method summarized above, or variations thereof.

Of course, the present disclosure is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 illustrates core software submodules and their functions of vegetation-trimming planning system, according to some embodiments of the present invention.

FIG. 2 shows a process flow for an example feeder-level analysis and outage prediction system.

FIG. 3 illustrates overlaying a map of NDVI with a line segment and applying a Gaussian kernel to the NDVI values, according to some embodiments.

FIG. 4 illustrates an example of a set of screening variables building a reward model, according to some embodiments.

FIG. 5 illustrates another example of a set of screening variables building a reward model, according to some embodiments.

FIG. 6 shows how different protective zones may be represented, according to some embodiments.

FIG. 7 illustrates an example output of a system for planning vegetation trimming.

FIG. 8 is a process flow diagram illustrating an example method for planning vegetation trimming, according to some embodiments.

FIG. 9 is a block diagram of an example apparatus for planning vegetation trimming.

### DETAILED DESCRIPTION

The techniques and systems described herein are based on a prescriptive vegetation management software framework to mitigate vegetation-related power outages in distribution systems. These techniques and systems aim to enhance power reliability and resilience by leveraging historical utility outage data, high-resolution satellite imagery, and advanced analytics. Embodiments can provide prescriptive tree trim plans, including generation of heatmaps to suggest the trimming area, while maximizing return, in terms of system reliability and resilience, on the invested (vegetation trimming) capital, assuring the highest return on invested capital, e.g., in terms of System Average Interruption Duration Index (SAIDI) and/or System Average Interruption Frequency Index (SAIFI) reduction.

The output from the methods and systems described herein in is prescriptive in nature, providing granular (e.g., at resolutions in centimeters or meters) guidance on where to trim vegetation and how much (e.g., in terms of distance from the electric grid component) to achieve desired grid performance within the most appropriate economic environment.

Some of the embodiments described herein provide a vegetation trimming heat map that maximizes return, in terms of parameters indicative of system reliability and resilience, on the investments made in vegetation trimming. With the input of a desired budget, the techniques can be used to provide a pixel-level heatmap indicating where to perform vegetation management and the required vegetation volume (e.g., in terms of ground surface area) that needs to go under vegetation trimming process. Alternatively or in addition, with inputs specifying desired system performance improvements, such as SAIDI/SAIFI reduction, the techniques may be used to provide the pixel heatmap where to perform vegetation management and the required vegetation volume (ground surface area) that needs to go under vegetation trimming process, while minimizing required financial investment.

In embodiments described herein, system reliability and resilience performance is a controllable function, leading to outputs of vegetation-trimming binary decisions for all pixels on a geographical image. Each pixel is of a certain physical size, such as 3 by 3 meters. Some of these pixels reside on (i.e., overlap with the surface area occupied by or overlaid by) an electrical structure, such as small piece of an electrical conductor, and other pixels reside next to the electrical components. The vegetation trimming decisions may be generated from a model that links the historic electric system reliability/resilience performance, system characteristics and vegetation index captured by imagery over time and seasons. An economic model, coupled to this reliability model, allows the system to take desired goals and inputs and provide a heatmap and schedule for vegetation management.

Technological innovations embodied in various embodiments of the techniques and systems described herein include an innovative methodology to develop a vegetation proxy index to quantify the vegetation impact on the power lines. The index data for quantifying the vegetation threat on distribution lines can be generated in various levels for different application in different scenarios. For example: (1) a high-resolution pixel-level index can be used to generate suggestions of tree trimming areas for detailed and prescriptive vegetation management planning; (2) a line-segment-level index can describe vegetation impacts on segment including, for example, only a few line spans, which can be used to monitor vegetation coverage in power corridors; and (3) feeder-level index data can provide quantification of vegetation impacts on each feeder, which can be used for feeder level analysis, modeling and planning.

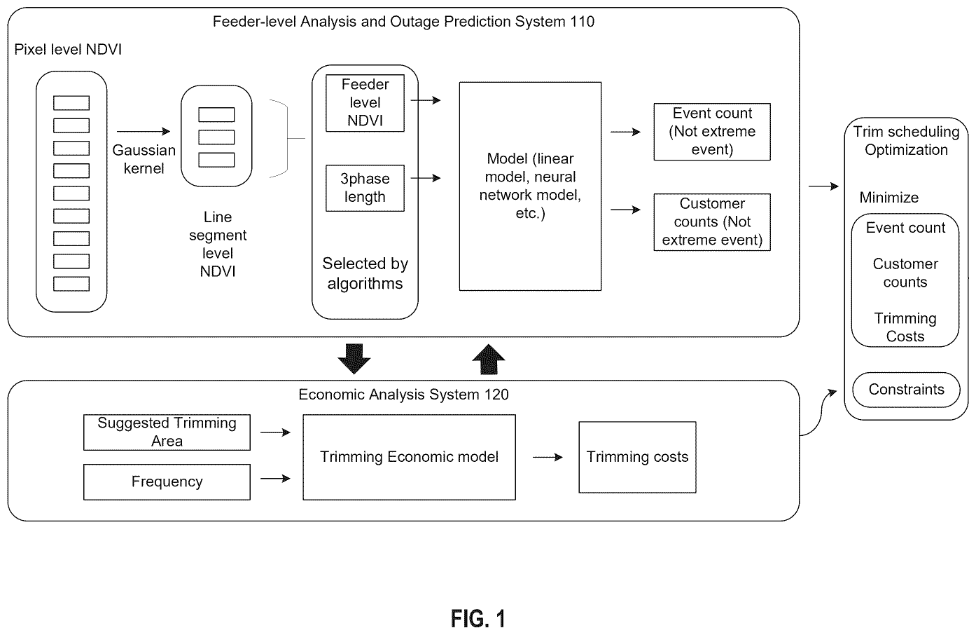

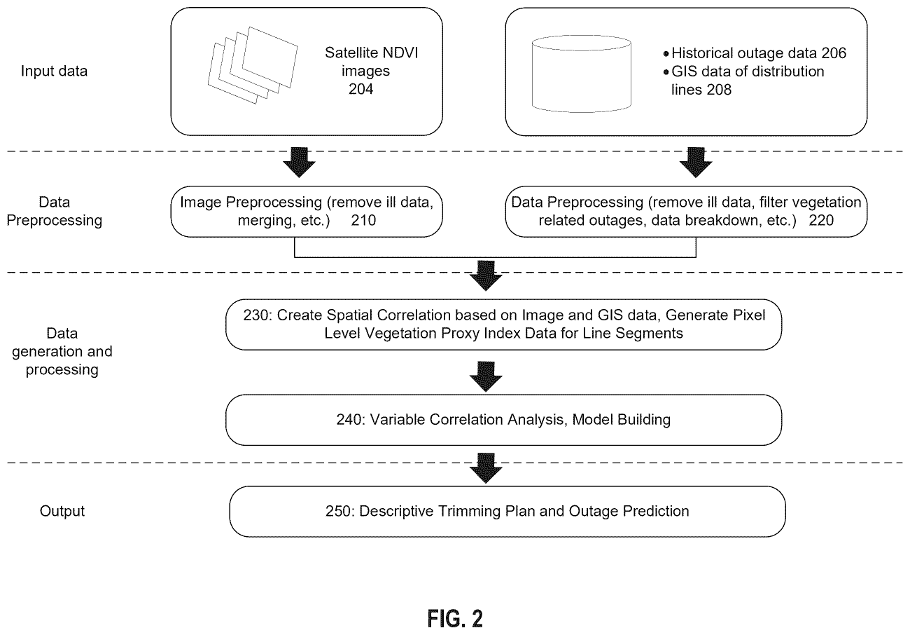

FIG. 1 illustrates core software submodules and their functions, in an example embodiment of the present invention. The framework includes two sub systems: the feeder level analysis and outage prediction system 110, which provides outage predictions based on high-resolution Normalized Difference Vegetation Index (NDVI) imagery; and the economic analysis system 120. A process flow for an example feeder-level analysis and outage prediction system 110 is shown in FIG. 2. Its detailed description is as follows.

The outage prediction system 110 illustrated in FIG. 2 includes two data preprocessing submodules, including an image data preprocessing submodule 210 and an outage data preprocessing submodule 220. Specifically, input image data, which may include satellite NDVI images 204 is preprocessed in submodule 210, for example, by removing ill data, merging multiple incomplete images, and other data conditioning operations. By “ill data” is meant irregularities or obvious errors or incomplete data among the input data. The outage data is preprocessed by submodule 220 to filter relevant data samples, for example, vegetation-related outage data, permanent outage event data, extreme weather data, or non-extreme weather event data, etc. The data are broken down based on associated power infrastructure information, such as number of phases, voltage levels, line materials, protective device zone, etc. For example, outage data may need to be broken down in outage categories, outage restauration steps may need to be identified and removed from the data set to keep only origination of outage so it can be counted/aggregated.

Submodule 230 uses an innovative methodology to develop a vegetation proxy index for distribution lines, to quantify the vegetation impact on power lines at various scales, such as at pixel level, line segment level, protective device zone level, and/or feeder level, for multiple application scenarios. This index is developed based on a Gaussian kernel method to process the NDVI data that indicates vegetation density, which is extracted from lower satellite imagery. The Gaussian kernel ensures that the impact on power lines of each distribution line segment's neighboring area is accounted for, providing detailed information on vegetation exposure along the line segments. The index data may be generated in any of various levels for different application scenarios. For example, the index data may be high-resolution vegetation index at the pixel level, or an index for each line segment that can cover as little as a few or several line spans, or an index at a higher feeder level. In addition, this submodule 230 can generate a heatmap that suggests potential tree trimming areas, based on, for example, the high-resolution pixel level index data, to provide detailed and descriptive tree trimming plan. At this level, the heatmap may reflect suggested tree/vegetation trimming based on the proxy index data, prior to consideration of economic input, thus reflecting areas where the risks of system disruption by vegetation are high or, correspondingly, where trimming areas should be prioritized.

Submodule 240 analyzes the correlations of variables, such as line length, customer numbers, and the newly developed vegetation proxy index, and generates models based on data-driven modeling techniques, such as the Poisson log-linear regression. Submodule 250 can use these modules and the vegetation proxy index data to output a descriptive trimming plan and/or predictions of after-trimming results, e.g., in terms of predictions of outage events and affected customer numbers, based on the suggested trimming areas and economic data. This output may also include heatmap-based plans, where the suggested trimming areas are modified to optimize the return, in terms of improved system reliability and/or resilience, on investment.

As seen in the previous discussion, spatial correlation of risks and proximity of risks to line segments to historic vegetation outages allows for development of prediction model, which in turn allows for utilization of the economic model to generate trimming plans to meet a certain budget or to meet certain goals for improvements in system reliability and resilience.

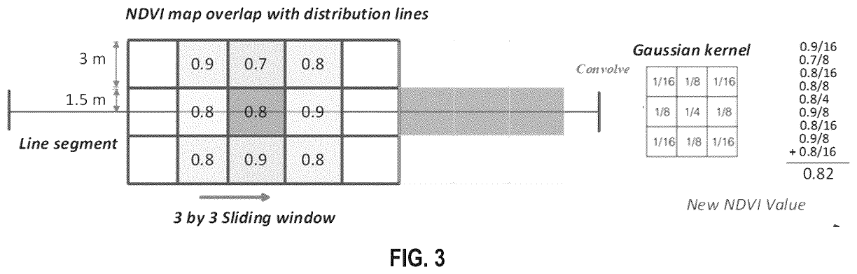

The spatial correlation processing performed by submodule 230 may include Gaussian kernel processing. In embodiments, this processing comprises pulling satellite images at an appropriate resolution (e.g., 3×3 meters), then ordering the images in chronological order (e.g., older to newer). These images are then aligned geographically, to overlay pixel positions. This allows tracking of vegetation exposure changes over time, at the pixel level (e.g., 3×3 meters). Electrical distribution system assets are also overlaid on the geographical map, e.g., based on longitude-latitude data associated with those assets. As an example, FIG. 3 shows how a map reflecting NDVI can be overlaid with a line segment (e.g., a few hundred feet of 3-phase conductor), and then a Gaussian kernel applied, to produce new NDVI values.

In this example, the vegetation index is calculated by using a sliding window. For example, the vegetation index for the center square shown in FIG. 3 above will have the first decimal rounded value of 0.8 based on Gaussian kernel weights shown to the right in the image above. Notice that the process moves along the line to determine vegetation index for each 3-meter section of the line by accounting for NDVI of center, left and right square on the line as well as adjacent squares to those that are right on the line segment, accounting for exposure of vegetation adjacent to the line. Once these vegetation index values are obtained for the entire line section (e.g., 100 values for 300 meters long line section), risk factors can be generated for every resolution step (e.g., 3 meters)—this informs the risk heat map. This-high resolution (e.g., 3 m) risk value on each (e.g., 3 m) line section allows for an aggregation of risk to an entire line section (call it “LVI”), a group of line sections (e.g., circuit breaker and recloser protective zone, call it “GVI”), or an entire circuit (call it “CVI”). An area=level NDVI proxy is created by aggregating values for line sections—the aggregation model starts from the line section level (e.g., average on vegetation indices or using other weighting method).

For example:
NDVI_proxy=A_{3×3}×G_{3×3}, A is area and G is the Gaussian kernel value (0.82 in the example above)
LVI=(sum of individual NDVI_proxy values)/(line_segment_length (m)/resolution (m))
GVI=sum of length weighted LVI
CVI=sum of length weighted GVI (Below we refer to vegetation proxy index, which represents CVI for overall circuit level prescriptive prediction model construction).

Then, data can be prepared to create a reward model, which will inform the economic model. The reward model establishes a relationship between the electric system characteristics (e.g., overhead (OH) line exposure to sunlight, not only vegetation in proximity), vegetation risk and historic outage data (e.g., SAIFI reliability performance related to vegetation outages). Think of it as #Veg_Outages=OH_length×CVI, for example. This reward model is used by submodule 250, to produce the presecriptive trimming plan and/or outage prediction, based on economic modelling.

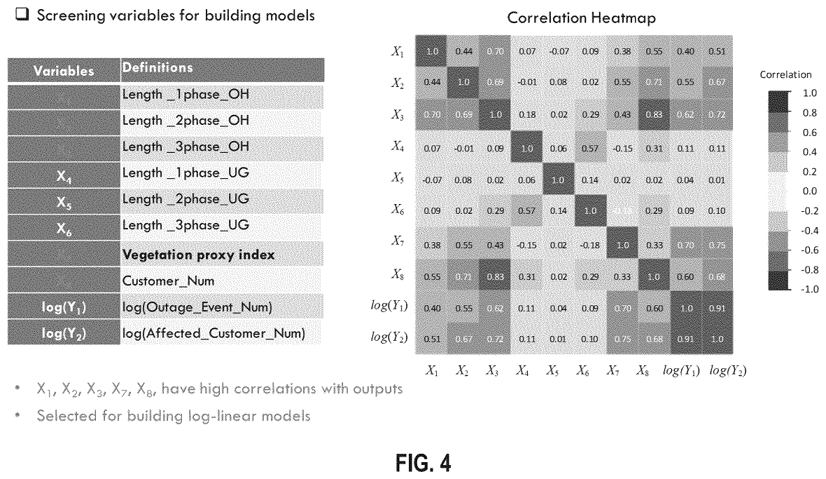

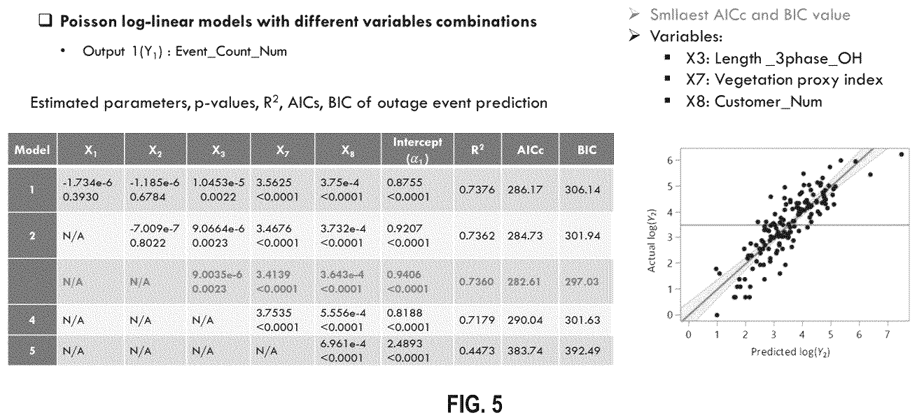

Any of numerous variables, such as length of underground and overhead 1-phase, 2-phase, and 3-phase line segments, may go into the reward module. FIG. 4 shows one example of a set of screening variables, for building the models with submodule 240, along with a correlation heatmap. FIG. 5 shows another example, with a simpler model build from just a few variables, in this case circuit characteristics (length of 3-phase line segments and number of customers present in the study area) and vegetation index proxy (e.g., CVI).

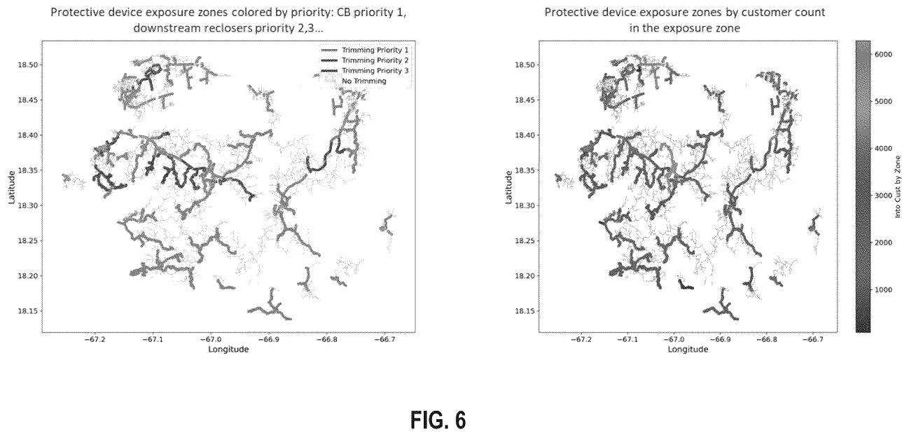

The prediction model allows the calculation, for example, number of vegetation related outages by adjusting vegetation index (with trimming actions) and OH line exposure (by undergrounding). Each of these actions has a cost associated with it, of course, such as the cost of trimming, per pixel area, and costs for undergrounding. Keep in mind that vegetation index is aggregated to a protective device and overall circuit level. The economic model can then take into account the protective zone alignment. For example, if a circuit breaker (CB) protective zone experiences outage from vegetation, that will impact all other protective device zones downstream of CB (causing outages for customers downstream of protective zone). So, there is different weighting factor for risks-reward model when protective device zone priority is taken into account. FIG. 6 show how different protective zones may be generated, in a small geographical area, as well number of customer associated with those zones. It will be appreciated that the information reflected in the gray-scale intensity maps in FIG. 6 can be enhanced by using color maps.

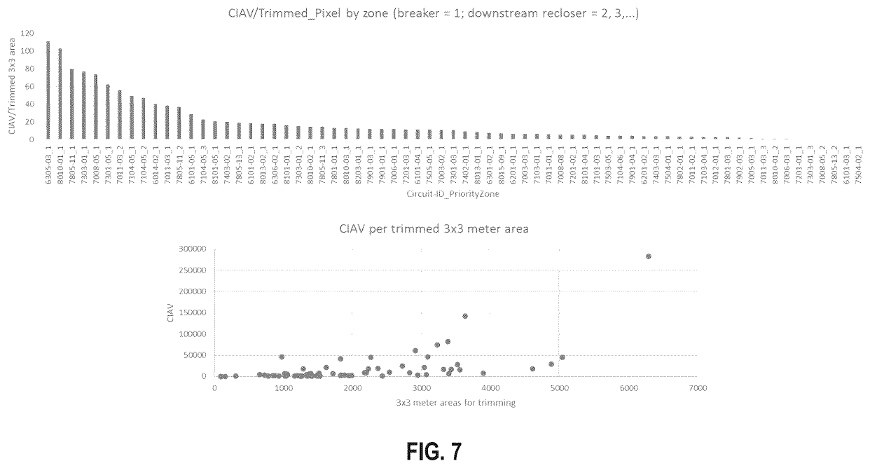

The output from applying the economic model to the prediction model may then identify the most optimal number and position of pixels (3×3 m) areas to trim, to meet objective. The objective can be, for example, to minimize customer-interruption minutes, while observing a limit in vegetation-trimming budget, or reducing outages to a certain number (e.g., 15%), at minimum trimming cost. The output may look something like FIG. 7, for example. In this example, vegetation management priorities are identified by circuit protective device zone and prioritized by return on investment (ROI), using customer interruptions avoided (CIAV) per identified 3×3 vegetation trim area locations. In this chart, each protective zone is given valuation in terms of CIAV.

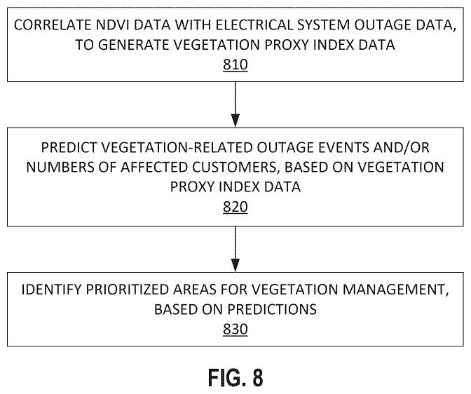

In view of the detailed description and examples provided above, it will be appreciated that the process flow diagram of FIG. 8 illustrates an example method for planning vegetation trimming for maintenance of an electric power distribution system, according to various embodiments of the techniques described above. Note that the absence of any of the details or variations described above from the illustrated method does not preclude their inclusion, in various instances or embodiments of the method.

As shown at block 810, the method comprises the step of correlating normalized difference vegetation index (NDVI) data extracted from satellite imagery with electrical system outage data mapped to power distribution system line segments, to generate vegetation proxy index data spatially associated with said power distribution line segments. The method further comprises, as shown at block 820, predicting vegetation related outage events and/or numbers of customers affected by device protective zone, based on the vegetation proxy index data. As shown at block 830, the method still further comprises identifying prioritized areas for vegetation management based on the predicted outage events and/or numbers of affected customers.

In some embodiments or instances of the method shown in FIG. 8, the step of predicting outage events and/or numbers of customers affected by outage events is further based on a model linking historical system reliability and resilience data for mapped electrical system components and historical vegetation index data. This correlating may comprise Gaussian kernel filtering of pixel-level NDVI data to generate power distribution line segment-level NDVI data and/or feeder-level NDVI data for input to said model. The model may be a linear model or a neural network model, or a combination of a linear model and a neural network model, in various embodiments.

In some embodiments or instances of the illustrated method, identifying the prioritized areas based on identified risk-reward within each protective device zone for vegetation management is further based on an economic model that estimates vegetation trimming costs based on suggested trimming areas and trimming frequencies. Identifying the prioritized areas for vegetation management may comprise generating a heatmap, in some embodiments or instances, where colors and/or intensities of the heatmap being indicative of prioritized areas for vegetation management.

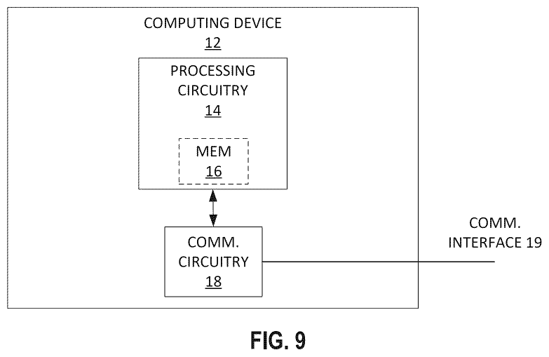

The various techniques and methods described above may be implemented with one or several computing devices, such as a network-based server, an individual computer or laptop computer, or a collection of cloud-based computing resources. FIG. 9 illustrates an example computing device 12 configured to perform all or part of one or more of the techniques described above, whether alone or in conjunction with one or more similar devices connected to the illustrated device 12 via a network.

Computing device 12 comprises processing circuitry 14 and communications circuitry 18. Communications circuitry 18 is configured for communication with one or more other computing devices over communication interface 19, e.g., via a network. Processing circuitry 14 comprises one or more processing elements, such as microprocessors, microcontrollers, digital signal processors, etc., and may also comprise additional digital logic and/or analog hardware, e.g., for sensor inputs, etc. Processing circuitry 14 further comprises memory 16, which may comprise one or several forms of memory such as non-volatile memory (e.g., flash memory), random access memory, etc. Some parts or all of the memory may be embedded in a processor device, or parts or all of the memory may be separate from processing devices, in various implementations.

In various embodiments, the computing device 12 is configured, e.g., with program code stored in memory 16 and designed for execution by one or more processing devices of the processing circuitry 14, to carry out all or parts of one or more of the techniques described above. Thus, in some embodiments, processing circuitry 14 is configured to correlate normalized difference vegetation index (NDVI) data extracted from satellite imagery with electrical system outage data mapped to power distribution system line segments, to generate vegetation proxy index data spatially associated with said power distribution line segments. Processing circuitry 14 may be further configured to predict vegetation related outage events and/or numbers of customers affected by device protective zone, based on the vegetation proxy index data, and to identify prioritized areas for vegetation management based on the predicted outage events and/or numbers of affected customers. In other embodiments, parts or all of some of these steps may be performed by other computing devices, with the outputs from these devices being shared, via communication circuitry 18, with processing circuitry 14, to perform at least the identifying operations discussed above.

Those skilled in the art will also appreciate that embodiments herein further include corresponding computer programs.

A computer program comprises instructions which, when executed on at least one processor of processing circuitry 14, cause the processing circuitry 14 to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of processing circuitry 14, cause the processing circuitry 14 to perform as described above.

Embodiments further include a computer program product comprising program code portions for performing the steps of any of the embodiments herein when the computer program product is executed processing circuitry 14. This computer program product may be stored on a computer readable recording medium.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole.

What is claimed is:

1. A method for planning vegetation trimming for maintenance of an electric power distribution system, the method comprising:
correlating normalized difference vegetation index (NDVI) data extracted from satellite imagery with electrical system outage data mapped to power distribution system line segments, to generate vegetation proxy index data spatially associated with said power distribution line segments;
predicting vegetation related outage events and/or numbers of customers affected by device protective zone, based on the vegetation proxy index data; and
identifying prioritized areas for vegetation management based on the predicted outage events and/or numbers of affected customers.

2. The method of claim 1, wherein predicting outage events and/or numbers of customers affected by outage events is further based on a model linking historical system reliability and resilience data for mapped electrical system components and historical vegetation index data.

3. The method of claim 2, wherein said correlating comprises Gaussian kernel filtering of pixel-level NDVI data to generate power distribution line segment-level NDVI data and/or feeder-level NDVI data for input to said model.

4. The method of claim 2, wherein said model is a linear model or a neural network model, or a combination of a linear model and a neural network model.

5. The method of claim 1, wherein identifying the prioritized areas is further based on an economic model that estimates vegetation trimming costs based on suggested trimming areas and trimming frequencies.

6. The method of claim 1, wherein identifying the prioritized areas for vegetation management comprises generating a heatmap, colors and/or intensities of the heatmap being indicative of prioritized areas for vegetation management.

7. One or more computing devices, configured for planning vegetation trimming for maintenance of an electric power distribution system, each of the one or more computing devices comprising processing circuitry and memory operatively coupled to the processing circuitry and storing program instructions for execution by the processing circuitry, whereby the processing circuitry among the one or more computing devices is configured to:
correlate normalized difference vegetation index (NDVI) data extracted from satellite imagery with electrical system outage data mapped to power distribution system line segments, to generate vegetation proxy index data spatially associated with said power distribution line segments;
predict vegetation related outage events and/or numbers of customers affected by device protective zone, based on the vegetation proxy index data; and
identify prioritized areas for vegetation management based on the predicted outage events and/or numbers of affected customers.

8. The one or more computing devices of claim 7, wherein the processing circuitry among the one or more computing devices is configured to predict the outage events and/or numbers of customers affected by outage events based further on a model linking historical system reliability and resilience data for mapped electrical system components and historical vegetation index data.

9. The one or more computing devices of claim 8, wherein the processing circuitry among the one or more computing devices is configured to perform Gaussian kernel filtering of pixel-level NDVI data to generate power distribution line segment-level NDVI data and/or feeder-level NDVI data for input to said model.

10. The one or more computing devices of claim 8, wherein said model is a linear model or a neural network model, or a combination of a linear model and a neural network model.

11. The one or more computing devices of claim 7, wherein the processing circuitry among the one or more computing devices is configured to identify the prioritized areas based further on an economic model that estimates vegetation trimming costs based on suggested trimming areas and trimming frequencies.

12. The one or more computing devices of claim 7, wherein the processing circuitry among the one or more computing devices is configured to identify the prioritized areas for vegetation management by generating a heatmap, wherein colors and/or intensities of the heatmap are indicative of prioritized areas for vegetation management.
